(19) United States
(12) Patent Application Publication
(10) Pub. No.: US 2020/0029605 A1
(43) Pub. Date: Jan. 30, 2020

(54) METHOD OF MAKING BACON STYLE SLICED PORK

(71) Applicant: Robert Steven Long, Indianola, IA (US)

(72) Inventor: Robert Steven Long, Indianola, IA (US)

(21) Appl. No.: 16/044,763

(22) Filed: Jul. 25, 2018

(51) Int. Cl. A23L 13/70; A22C 17/00

(52) U.S. Cl. CPC A23L 13/76; A23V 2002/00; A22C 17/0033

(57) ABSTRACT

A method of making bacon styled sliced pork by cutting a layer of muscle and fat from an outer surface of a pork ham. After smoking and curing the layer, the layer is rolled out and cut into blocks. The blocks are then fed into a slicing machine to make slices of bacon style pork.

### BACKGROUND OF THE INVENTION

This invention is directed to a method of making bacon style sliced pork and more particularly making bacon style sliced pork from a pork ham.

There are many cuts of pork such as a pork shoulder or butt, a pork belly, a pork ham, or the like. From these different cuts comes a number of pork products. For example, one of the more popular products that come from the pork belly is bacon. As a result of the popularity of bacon, not only are pork bellies sometimes in short supply, but they are also expensive in comparison to other cuts.

In contrast, pork hams are less popular and less expensive. Typically the pork ham is cooked as a whole or large circular slices are cut off the butt end. As a result of the difference in cost and popularity, there is a need in the art for a way to use pork hams as a replacement for pork bellies.

An objective of the present invention is to provide a method that produces a novel way of using a pork ham.

Another objective of the present invention is to provide a method of producing a less expensive alternative to bacon.

These and other objectives will be apparent to one having ordinary skill in the art based upon the following written description, drawings, and claims.

### SUMMARY OF THE INVENTION

A method for making bacon style sliced pork includes cutting a layer of muscle and fat from an outer surface of a pork ham. The layer is then smoked and cured. Next, the layer is rolled out flat and cut into blocks. The blocks are then fed to a slicing machine to form bacon style slices of pork.

### BRIEF DESCRIPTION OF THE DRAWINGS

FIG. 1 is a perspective view of a pork ham in various stages of production; and

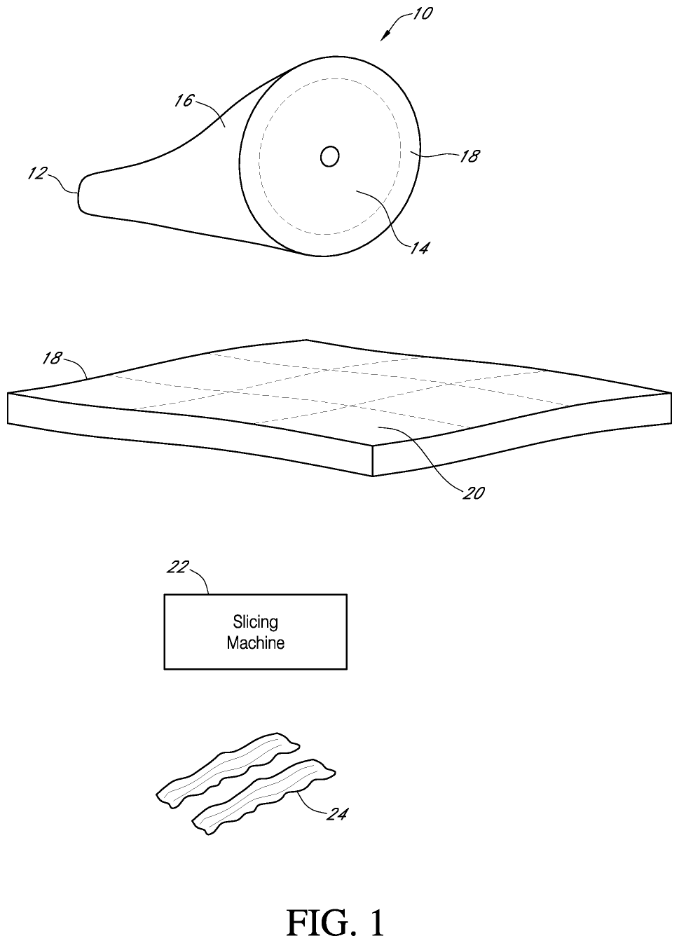

FIG. 2 is a flow diagram of a method of making bacon style sliced pork.

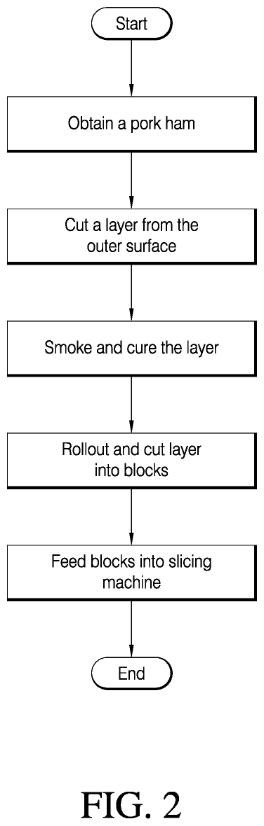

### DETAILED DESCRIPTION OF THE PREFERRED EMBODIMENTS

A method of making bacon style sliced pork begins by obtaining a pork ham 10 from the back thigh or rump of a pig. The pork ham 10 has a shank end 12, a butt end 14, and an outer surface 16. Next a layer 18 of muscle and fat is cut from the outer surface 16 of the pork ham 10. Preferably, the thickness of the layer 18 is between 1½ to 2 inches.

Once cut, the layer is rolled out flat and cut into blocks 20. Preferably the blocks are 12×12 inches in size. Once cut into blocks 20 the blocks 20 are pumped and cured using conventional methods. Finally, the blocks 20 are fed into a slicing machine 22 where the blocks 20 are cut into thin bacon like slices of pork ham 24.

In an alternative embodiment, the process is the same except the skin is left on the pork ham 10 and the blocks 20 are not fed to the slicing machine 22. The processed blocks of pork ham are then packed and used to make chicharrones.

What is claimed is:

1. A method of making bacon style sliced ham, comprising:
obtaining a pork ham having a shank end, a butt end, and an outer surface;
cutting a layer of muscle and fat from the outer surface of the pork ham;
smoking and curing the layer of muscle and fat;
rolling the layer of muscle and fat out;
cutting the rolled out layer of muscle and fat into blocks; and
feeding the cut blocks into a slicing machine.

2. The method of claim 1 wherein the layer of muscle and fat has a thickness of 1½ to 2 inches.

3. The method of claim 1 wherein the blocks are cut to a 12×12 inch size.
